(19) United States
(12) Patent Application Publication
(10) Pub. No.: US 2026/0034767 A1
(43) Pub. Date: Feb. 5, 2026

(54) LAMINATE FOR FUEL CELLS

(71) Applicant: Sumitomo Riko Company Limited, Aichi (JP)

(72) Inventors: Kentaro Imai, Aichi (JP); Kenji Yamamoto, Aichi (JP); Hirofumi Okuda, Aichi (JP)

(73) Assignee: Sumitomo Riko Company Limited, Aichi (JP)

(21) Appl. No.: 19/352,400

(22) Filed: Oct. 7, 2025

Related U.S. Application Data
(63) Continuation of application No. PCT/JP2024/025293, filed on Jul. 12, 2024.

(30) Foreign Application Priority Data
Jul. 31, 2023 (JP) 2023-124324

(51) Int. Cl. B32B 15/06; B32B 7/12; B32B 15/18; B32B 25/16

(52) U.S. Cl. CPC B32B 15/06; B32B 7/12; B32B 15/18; B32B 25/16; B32B 2311/30; B32B 2319/00; B32B 2457/18

(57) ABSTRACT

A laminate is formed in which a separator that serves as a base material and a lip that serves as a sealing member are bonded via an adhesive layer. The lip includes a rubber composition containing a component (A) described below. The adhesive layer includes an adhesive containing a component (α) and a component (β) described below. (A) A rubber component that is composed of at least one of an ethylene-propylene-diene rubber and an ethylene-butene-diene rubber. (a) A copolymerized oligomer type silane coupling agent that has a specific hydrophilic functional group and a specific hydrophobic functional group at a specific ratio. (B) An organic titanate compound.

### CROSS-REFERENCE TO RELATED APPLICATION

This application is a continuation of PCT International Application No. PCT/JP2024/025293, filed on Jul. 12, 2024, which claims priority under 35 U.S.C § 119(a) to Japanese Patent Application No. 2023-124324, filed on Jul. 31, 2023. Each of the above application(s) is hereby expressly incorporated by reference, in its entirety, into the present application.

### BACKGROUND

### Technical Field

The present disclosure relates to a laminate for fuel cells formed in which a base material and a sealing member are bonded via an adhesive layer. Specifically, the present disclosure relates to a laminate for fuel cells formed in which a base material for fuel cells such as a separator made of metal and a sealing member made of rubber are bonded via an adhesive layer.

### Related Art

A fuel cell that generates electricity through an electrochemical reaction of gases has high power generation efficiency, emits clean gases and has extremely little impact on the environment. Among fuel cells, a solid polymer type fuel cell can be operated at relatively low temperatures and has high output density. Hence, the solid polymer type fuel cell is expected to have various applications such as for power generation and automobile power sources.

In the solid polymer type fuel cell, a cell in which a membrane electrode assembly (MEA) or the like is sandwiched between separators (separators made of metal or the like) serves as a power generation unit. The MEA includes a polymer membrane (electrolyte membrane) serving as an electrolyte, and a pair of electrode catalyst layers [fuel electrode (anode) catalyst layer and oxygen electrode (cathode) catalyst layer] arranged on both sides in a thickness direction of the electrolyte membrane. On a surface of the pair of electrode catalyst layers, a porous layer (gas diffusion layer) for further diffusing gases is arranged. Fuel gas such as hydrogen is supplied to the fuel electrode side, and oxidant gas such as oxygen or air is supplied to the oxygen electrode side. Power generation is performed by an electrochemical reaction at a three-phase interface between the supplied gas, the electrolyte, and the electrode catalyst layer. The solid polymer type fuel cell is configured in which a cell stack in which multiple cells are stacked is tightened with end plates or the like arranged at both ends in a cell stacking direction.

In the separator, a flow path for the gas supplied to each electrode or a flow path for a coolant for mitigating heat generation during power generation is formed. Since the electrolyte membrane has proton conductivity in a state containing water, it is necessary to keep the electrolyte membrane in a wet state during operation. Accordingly, in order to prevent gas mixing or gas and coolant leakage and maintain the inside of the cell in a wet state, it is important to ensure sealing performance around the MEA and the porous layer and between adjacent separators. For that reason, a sealing member (gasket) for sealing each place mentioned above is required.

The sealing member is also exposed to water generated by power generation. Since this water contains sulfonic acid or the like eluted from the electrolyte membrane, acid-resistant adhesion is required in adhesion of the sealing member with respect to the separator.

The present applicant has already proposed a laminate for fuel cells formed in which a separator and a sealing member are bonded via an adhesive layer including a specific adhesive, from the viewpoint of enhancing acid-resistant adhesion (see WO 2022/208926). In the laminate for fuel cells, good acid-resistant adhesion is exhibited by using an adhesive containing a silane coupling agent, in which the silane coupling agent is of a copolymerized oligomer type having a specific hydrophilic functional group and a specific hydrophobic functional group and has a molar ratio (Ma/Mb) of a substance amount Ma (mol) of hydrophilic functional groups to a substance amount Mb (mol) of hydrophobic functional groups contained in 1 mol of molecules that is set within a specific range.

The laminate for fuel cells of WO 2022/208926 exhibits good acid-resistant adhesion. However, in recent years, there has been a tendency for power generation temperatures to rise for improving power generation efficiency, and new technological development is required to enhance the acid-resistant adhesion between the base material and the sealing member so that good adhesion can be obtained even under relatively severe conditions.

### SUMMARY

A laminate for fuel cells is formed in which a base material and a sealing member are bonded via an adhesive layer, in which the sealing member includes a rubber composition containing the following component (A); and the adhesive layer includes an adhesive containing the following component (α) and component (β):
(A) at least one of ethylene-propylene-diene rubber and ethylene-butene-diene rubber;
(α) a copolymerized oligomer type silane coupling agent having a hydrophilic functional group and a hydrophobic functional group, in which the hydrophilic functional group is the following (a), the hydrophobic functional group is the following (b), and a molar ratio (Ma/Mb) of a substance amount Ma (mol) of hydrophilic functional groups to a substance amount Mb (mol) of hydrophobic functional groups contained in 1 mol of molecules is 0.33 to 3.00:
   (a) at least one selected from a group consisting of silanol group, alkoxy group, amino group, isocyanate group, epoxy group, ureido group, carboxy group, and hydroxy group, and containing at least silanol group or alkoxy group;
   (b) at least one selected from a group consisting of vinyl group, (meth)acryloyl group, maleimide group, methyl group, ethyl group, styryl group, phenyl group, and mercapto group;
(β) an organic titanate compound.

### BRIEF DESCRIPTION OF THE DRAWINGS

FIG. 1 is a cross-sectional view showing an example of a laminate for fuel cells according to the present disclosure.

FIG. 2 is a cross-sectional view showing an example of a fuel cell seal body using the laminate for fuel cells according to the present disclosure.

### DESCRIPTION OF THE EMBODIMENTS

The present disclosure provides a laminate for fuel cells that exhibits excellent acid-resistant adhesion.

The present inventors have found that, by using, as an adhesive for bonding a base material and a sealing member including a specific rubber composition, an adhesive in which a specific silane coupling agent and an organic titanate compound are combined, the acid-resistant adhesion between the base material and the sealing member can be enhanced, and excellent acid-resistant adhesion is exhibited even under the conditions of high temperature and long period.

That is, the present disclosure is summarized as [1] to [4] below.
[1] A laminate for fuel cells, formed in which a base material and a sealing member are bonded via an adhesive layer, in which the sealing member includes a rubber composition containing the following component (A); and the adhesive layer includes an adhesive containing the following component (α) and component (β):
(A) at least one of ethylene-propylene-diene rubber and ethylene-butene-diene rubber;
(α) a copolymerized oligomer type silane coupling agent having a hydrophilic functional group and a hydrophobic functional group, in which the hydrophilic functional group is the following (a), the hydrophobic functional group is the following (b), and a molar ratio (Ma/Mb) of a substance amount Ma (mol) of hydrophilic functional groups to a substance amount Mb (mol) of hydrophobic functional groups contained in 1 mol of molecules is 0.33 to 3.00:
   (a) at least one selected from a group consisting of silanol group, alkoxy group, amino group, isocyanate group, epoxy group, ureido group, carboxy group, and hydroxy group, and containing at least silanol group or alkoxy group;
   (b) at least one selected from a group consisting of vinyl group, (meth)acryloyl group, maleimide group, methyl group, ethyl group, styryl group, phenyl group, and mercapto group;
(β) an organic titanate compound.
[2] The laminate for fuel cells as described in [1], in which the component (β) in the adhesive is at least one of titanium alkoxide and titanium chelate.
[3] The laminate for fuel cells as described in [1] or [2], in which a blending amount of the component (β) in the adhesive is 0.5 to 200 parts by mass relative to 100 parts by mass of the component (α).
[4] The laminate for fuel cells as described in any one of [1] to [3], in which the base material is a base material including austenitic stainless steel.

According to the present disclosure, a laminate for fuel cells can be provided that exhibits excellent acid-resistant adhesion.

Particularly, a laminate for fuel cells can be provided that is excellent in acid-resistant adhesion under the conditions of high temperature and long period.

Next, an embodiment of the present disclosure will be described in detail. However, the present disclosure is not limited to this embodiment.

In the present specification, (meth)acryloyl group means acryloyl group or methacryloyl group, and (meth)acrylate means acrylate or methacrylate.

A laminate for fuel cells (hereinafter sometimes referred to as “the present laminate for fuel cells”) according to one embodiment of the present disclosure is a laminate for fuel cells formed in which a base material and a sealing member are bonded via an adhesive layer, and is characterized in that the sealing member includes a rubber composition (hereinafter sometimes referred to as “the present rubber composition”) containing the following component (A), and that the adhesive layer includes an adhesive containing the following component (α) and component (β):
(A) at least one of ethylene-propylene-diene rubber and ethylene-butene-diene rubber;
(α) a copolymerized oligomer type silane coupling agent having a hydrophilic functional group and a hydrophobic functional group, in which the hydrophilic functional group is the following (a), the hydrophobic functional group is the following (b), and a molar ratio (Ma/Mb) of a substance amount Ma (mol) of hydrophilic functional groups to a substance amount Mb (mol) of hydrophobic functional groups contained in 1 mol of molecules is 0.33 to 3.00:
   (a) at least one selected from a group consisting of silanol group, alkoxy group, amino group, isocyanate group, epoxy group, ureido group, carboxy group, and hydroxy group, and containing at least silanol group or alkoxy group;
   (b) at least one selected from a group consisting of vinyl group, (meth)acryloyl group, maleimide group, methyl group, ethyl group, styryl group, phenyl group, and mercapto group;
(β) an organic titanate compound.

The laminate for fuel cells of WO 2022/208926, which is the aforesaid related art, for example, exhibits good acid-resistant adhesion after being immersed in a sulfuric acid aqueous solution (pH=3.0) at 90° C. for 168 hours or 336 hours. However, in some cases, for example, under severe conditions such as in a relatively high-temperature environment or for a relatively long period, there is room for improvement in acid-resistant adhesion. For example, the laminate for fuel cells of WO 2022/208926 has room for improvement in the acid-resistant adhesion after immersion in a sulfuric acid aqueous solution (pH=3.0) at 120° C. for 336 hours which are relatively severe conditions.

According to the present laminate for fuel cells, good acid-resistant adhesion can be maintained even under severe conditions such as in a relatively high-temperature environment or for a long period. For example, according to the present laminate for fuel cells, good acid-resistant adhesion is exhibited even after immersion in a sulfuric acid aqueous solution (pH=3.0) at a high temperature of 120° C. for a long period of 336 hours. Hence, adhesion reliability can be further enhanced compared to the related art.

Surprisingly, the present laminate for fuel cells, for example, exhibits good acid-resistant adhesion even after immersion in a sulfuric acid aqueous solution (pH=3.0) at a high temperature of 120° C. for a longer period of 672 hours. Hence, adhesion reliability can be dramatically enhanced compared to the related art.

Particularly, in the case of using, for example, titanium alkoxide, as the organic titanate compound (β) blended in the adhesive layer of the present laminate for fuel cells, for example, even after immersion in a sulfuric acid aqueous solution (pH=3.0) at 120° C. for an even longer period of 840 hours, good acid-resistant adhesion is exhibited. Hence, the present laminate for fuel cells is particularly highly useful.

Hereinafter, the sealing member, adhesive layer, and base material that constitute the present laminate for fuel cells will be described.

### <Sealing Member>

First, each material of the present rubber composition for forming the sealing member will be described.

### <<Rubber Component (A)>>

As the rubber component (A), at least one of ethylene-propylene-diene rubber (EPDM) and ethylene-butene-diene rubber (EBT) may be used. From the viewpoint of further enhancing the acid-resistant adhesion of the sealing member, particularly the acid-resistant adhesion under the conditions of high temperature and long period, or from the viewpoint of sealing performance, it is preferable to use EBT as the rubber component (A).

A diene amount (mass ratio of diene component) of EPDM and EBT is preferably in the range of, for example, 3% to 15% by mass, more preferably in the range of 3.5% to 14.5% by mass.

As the diene component of EPDM and EBT, for example, a diene monomer having 5 to 20 carbon atoms is preferable, and specific examples include: 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene (DCP), 5-ethylidene-2-norbornene (ENB), 5-vinyl-2-norbornene (VNB), 5-butylidene-2-norbornene, 2-methallyl-5-norbornene, and 2-isopropenyl-5-norbornene.

An ethylene amount (mass ratio of ethylene component) of EPDM is preferably in the range of, for example, 35% to 50% by mass, more preferably in the range of 40% to 50% by mass. A propylene amount (mass ratio of propylene component) is preferably in the range of, for example, 42% to 55% by mass, more preferably in the range of 44% to 50% by mass.

The ethylene amount (mass ratio of ethylene component) of EBT is preferably in the range of, for example, 35% to 55% by mass, more preferably in the range of 40% to 53% by mass. A butene amount (mass ratio of butene component) is preferably in the range of, for example, 35% to 55% by mass, more preferably in the range of 38% to 50% by mass.

The rubber component (A) is a principal component of the present rubber composition and usually accounts for 40% by mass or more of the entire present rubber composition. A blending amount of the rubber component (A) is preferably in the range of, for example, 40% to 80% by mass, more preferably in the range of 45% to 75% by mass, relative to the entire present rubber composition.

In addition to the rubber component (A), various additives that may be used in common rubber compositions, such as a plasticizer, filler, crosslinking agent (such as organic peroxide), crosslinking aid, and antioxidant, can be blended into the present rubber composition.

### <<Plasticizer>>

Examples of the plasticizer include: a petroleum-based plasticizer, such as process oil, lubricating oil, paraffin, liquid paraffin, and vaseline; a fatty oil-based plasticizer, such as castor oil, linseed oil, rapeseed oil, and coconut oil; waxes, such as tall oil, sub, beeswax, carnauba wax, and lanolin; linoleic acid; palmitic acid; stearic acid; and lauric acid. One of them may be used alone, or two or more thereof may be used in combination.

A blending amount of the plasticizer is usually 60 parts by mass or less, preferably in the range of 5 to 50 parts by mass, more preferably in the range of 8 to 40 parts by mass, relative to 100 parts by mass of the rubber component (A). The blending amount of the plasticizer may be in the range of 10 to 30 parts by mass or in the range of 10 to 25 parts by mass relative to 100 parts by mass of the rubber component (A).

Among plasticizers, a plasticizer having a pour point of −30° C. or lower is preferable, and a plasticizer having a pour point of −40° C. or lower is more preferable. Examples of such a plasticizer include: poly-α-olefin, dioctyl phthalate (DOP), dioctyl adipate (DOA), dioctyl sebacate (DOS), and dibutyl sebacate (DBS). One of them may be used alone, or two or more thereof may be used in combination. Among them, poly-α-olefin is preferable from the viewpoint of good compatibility with the rubber component (A) and difficulty in bleeding. Poly-α-olefin is obtained by polymerizing α-olefin having 6 to 16 carbon atoms. In the poly-α-olefin, the smaller the molecular weight, the smaller the viscosity and the lower the pour point.

As described above, a plasticizer having a low pour point is less likely to harden at extremely low temperatures. Accordingly, the lower the pour point of the plasticizer, the greater the effect of suppressing crystallization of the rubber component at extremely low temperatures. On the other hand, if the pour point is excessively low, volatilization is likely to occur during operation of the fuel cell or the like. Thus, it is desirable that the pour point of the plasticizer be −80° C. or higher.

The pour point can be measured in accordance with JIS K 2269 (1987).

The kinematic viscosity of the plasticizer at 40° C. is preferably in the range of 8 to 500 mm²/s, more preferably in the range of 9 to 460 mm²/s. A reason is that, if a plasticizer exhibiting such kinematic viscosity is used, since compatibility with rubber is good and volatility is low, excellent compression set properties (low set properties) are achieved. The kinematic viscosity of the plasticizer is measured in accordance with JIS K 2283.

### <<Filler>>

Examples of the filler include carbon black and silica. One of them may be used alone, or two or more thereof may be used in combination. The grade of the carbon black is not particularly limited, and examples include: SAF grade, ISAF grade, HAF grade, MAF grade, FEF grade, GPF grade, SRF grade, FT grade, and MT grade.

From the viewpoint of adhesion with the adhesive layer or the like, the filler is preferably a filler containing carbon black, and may be carbon black alone.

A blending amount of the filler is usually in the range of 10 to 150 parts by mass, preferably in the range of 20 to 100 parts by mass, relative to 100 parts by mass of the rubber component (A). The blending amount of the filler may be in the range of 25 to 80 parts by mass or in the range of 30 to 70 parts by mass relative to 100 parts by mass of the rubber component (A).

### <<Crosslinking Agent>>

As the crosslinking agent, an organic peroxide is preferable, and an organic peroxide having a 1-hour half-life temperature of 160° C. or lower is preferable. Examples of the organic peroxide include: dialkyl peroxide, peroxy ketal, peroxy ester, ketone peroxide, diacyl peroxide, and peroxy dicarbonate. One of them may be used alone, or two or more thereof may be used in combination. Among them, for the reason that a rubber composition kneaded with the crosslinking agent is excellent in scorch resistance and reactivity with the adhesive, it is preferable to use at least one selected from a group consisting of dialkyl peroxide, peroxy ketal, and peroxy ester each having a 1-hour half-life temperature of 100° C. to 160° C., and it is particularly preferable to use at least one selected from a group consisting of dialkyl peroxide, peroxy ketal, and peroxy ester each having a 1-hour half-life temperature of 110° C. to 160° C.

Here, “half-life” is the time until the concentration of the organic peroxide becomes half of an initial value. Thus, “half-life temperature” serves as an index indicating a decomposition temperature of the organic peroxide. The “1-hour half-life temperature” is the temperature at which the half-life becomes 1 hour. That is, the lower the 1-hour half-life temperature, the easier the decomposition at low temperature and the faster the reaction rate. If the 1-hour half-life temperature is excessively low, scorch is likely to occur and reacting with the adhesive becomes difficult.

Examples of the dialkyl peroxide include: di(2-t-butylperoxyisopropyl)benzene, dicumyl peroxide, 2,5-dimethyl-2,5-di(t-butylperoxy)hexane, t-butylcumyl peroxide, di-t-hexyl peroxide, di-t-butyl peroxide, and 2,5-dimethyl-2,5-di(t-butylperoxy) hexyne-3.

Examples of the peroxy ketal include: n-butyl-4,4-di(t-butylperoxy)valerate, 2,2-di(t-butylperoxy)butane, 2,2-di(4,4-di(t-butylperoxy)cyclohexyl) propane, 1,1-di(t-butylperoxy)cyclohexane, 1,1-di(t-hexylperoxy)cyclohexane, 1,1-di(t-hexylperoxy)-3,3,5-trimethylcyclohexane, and 1,1-di(t-butylperoxy)-2-methylcyclohexane.

Examples of the peroxy ester include: t-butyl peroxybenzoate, t-butyl peroxyacetate, t-propyl peroxyacetate, t-hexyl peroxybenzoate, 2,5-dimethyl-2,5-di(benzoylperoxy)hexane, t-butyl peroxy-2-ethylhexyl monocarbonate, t-butyl peroxylaurate, t-butyl peroxyisopropyl monocarbonate, t-butyl peroxy-3,5,5-trimethylhexanoate, t-butyl peroxymaleic acid, and t-hexyl peroxyisopropyl monocarbonate.

Among them, due to high reactivity with the rubber component (A), 1,1-di(t-hexylperoxy)cyclohexane, 1,1-di(t-butylperoxy)cyclohexane, n-butyl-4,4-di(t-butylperoxy)valerate, 2,2-di(t-butylperoxy)butane, t-butyl peroxybenzoate, t-butyl peroxy-2-ethylhexyl monocarbonate, t-hexyl peroxybenzoate, 2,5-dimethyl-2,5-di(benzoylperoxy)hexane, di(2-t-butylperoxyisopropyl)benzene, dicumyl peroxide, 2,5-dimethyl-2,5-di(t-butylperoxy)hexane, t-butylcumyl peroxide, di-t-hexyl peroxide, di-t-butyl peroxide, and 2,5-dimethyl-2,5-di(t-butylperoxy) hexyne-3 are preferable. Particularly preferable are 1,1-di(t-butylperoxy)cyclohexane, n-butyl-4,4-di(t-butylperoxy)valerate, 1,1-di(t-hexylperoxy)cyclohexane, t-hexyl peroxybenzoate, 2,5-dimethyl-2,5-di(benzoylperoxy)hexane, 2,5-dimethyl-2,5-di(benzoylperoxy)hexane, di(2-t-butylperoxyisopropyl)benzene, dicumyl peroxide, 2,5-dimethyl-2,5-di(t-butylperoxy)hexane, and t-butylcumyl peroxide.

A blending amount of the crosslinking agent (in the case of a raw component with 100% purity) is preferably, for example, in the range of 0.4 to 12 parts by mass relative to 100 parts by mass of the rubber component (A). If the blending amount of the crosslinking agent is excessively small, there is a tendency to become difficult to sufficiently advance a crosslinking reaction. If the blending amount of the crosslinking agent is excessively large, there is a tendency for the crosslinking density to rapidly increase during the crosslinking reaction, leading to a decrease in adhesion force.

In the case of not using a raw component with 100% purity as the organic peroxide, the organic peroxide is blended so that a proportion in terms of the raw component is within the above range.

### <<Crosslinking Aid>>

Examples of the crosslinking aid include: a maleimide compound, triallyl cyanurate (TAC), triallyl isocyanurate (TAIC), trimethylolpropane trimethacrylate (TMPT), bifunctional (meth)acrylate, and 1,2-polybutadiene. One of them may be used alone, or two or more thereof may be used in combination. Among them, due to an effect of greatly improving crosslinking density or strength, it is preferable to use a maleimide compound or TAIC.

A blending amount of the crosslinking aid is preferably 5 parts by mass or less relative to 100 parts by mass of the rubber component (A). If the blending amount of the crosslinking aid is excessively large, there is a tendency for the crosslinking density to rapidly increase during the crosslinking reaction, leading to a decrease in tensile elongation or adhesion force.

### <<Antioxidant>>

Examples of the antioxidant include: an amine-based antioxidant, a phenol-based antioxidant, an imidazole-based antioxidant, a phosphoric acid-based antioxidant, and wax. One of them may be used alone, or two or more thereof may be used in combination.

Specific examples include: an amine-based antioxidant, such as N-phenyl-1-naphthylamine, N,N′-diphenyl-p-phenylenediamine, N,N′-di-2-naphthyl-p-phenylenediamine, N-phenyl-N′-isopropyl-p-phenylenediamine, di(4-octylphenyl)amine, 4,4′-bis(α,α-dimethylbenzyl)diphenylamine, p-(p-toluenesulfonylamino)diphenylamine, and N-phenyl-N′-(1,3-dimethylbutyl)-p-phenylenediamine; a phenol-based antioxidant, such as 2,6-di-t-butyl-4-methylphenol, 2,6-di-t-butyl-4-ethylphenol, 2,6-di-t-butylphenol, 2,4,6-tri-t-butylphenol, styrenated phenol, 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), 4,4′-methylenebis(2,6-t-butylphenol), 4,4′-isopropylidenebis(2,6-di-t-butylphenol), and 2,2′-isobutylidenebis(4,6-dimethylphenol); and an imidazole-based antioxidant, such as 2-mercaptobenzimidazole, 2-mercaptobenzimidazole zinc salt, and 2-mercaptomethylbenzimidazole.

A blending amount of the antioxidant is usually in the range of 0.1 to 10 parts by mass relative to 100 parts by mass of the rubber component (A). The blending amount of the antioxidant can be appropriately set within the above range, and may be, for example, 1 to 8 parts by mass, or 2 to 6 parts by mass.

The present rubber composition may contain an adhesive component (such as a silane coupling agent). However, from the viewpoint of enhancing the releasability during molding of the sealing member, it is preferable that the present rubber composition does not contain (is free of) an adhesive component. Hence, a blending amount of the adhesive component (such as a silane coupling agent) is preferably less than 0.1% by mass, more preferably less than 0.01% by mass, and even more preferably 0% by mass, relative to the entire present rubber composition.

### <<Preparation of Rubber Composition>>

By kneading the rubber component (A) and, as necessary, various additives such as a plasticizer, filler, organic peroxide (crosslinking agent), crosslinking aid, antioxidant, or processing aid, using a roll, kneader, Banbury mixer or the like, the present rubber composition for forming the sealing member is prepared. As will be described later, by subjecting the present rubber composition to die molding, press molding or the like, a sealing member having a predetermined thickness is formed.

### <Adhesive Layer>

Next, the adhesive layer that bonds the sealing member including the present rubber composition and the base material will be described. As an adhesive for forming the adhesive layer, it is important to use an adhesive containing the following components (α) and (β). With an adhesive containing only one of the following components (α) and (β), it tends to be difficult to enhance the acid-resistant adhesion between the sealing member and the base material under the conditions of high temperature and long period.

### <<Silane Coupling Agent (α)>>

The component (α) is a copolymerized oligomer type silane coupling agent having a hydrophilic functional group and a hydrophobic functional group, in which the hydrophilic functional group is the following (a), the hydrophobic functional group is the following (b), and a molar ratio (Ma/Mb) of a substance amount Ma (mol) of hydrophilic functional groups to a substance amount Mb (mol) of hydrophobic functional groups contained in 1 mol of molecules is 0.33 to 3.00:
(a) at least one selected from a group consisting of silanol group, alkoxy group, amino group, isocyanate group, epoxy group, ureido group, carboxy group, and hydroxy group, and containing at least silanol group or alkoxy group;
(b) at least one selected from a group consisting of vinyl group, (meth)acryloyl group, maleimide group, methyl group, ethyl group, styryl group, phenyl group, and mercapto group.

As described above, the silane coupling agent shown in (α) has one type or multiple types of hydrophilic functional groups shown in (a) (in which silanol group or alkoxy group is essential, and others are optional), and also has one type or multiple types of hydrophobic functional groups shown in (b).

From the viewpoint of reactivity with the base material and reactivity with the sealing member, among the hydrophilic functional groups shown in (a), silanol group (hydroxy group constituting a silanol structure), alkoxy group, amino group, and isocyanate group are preferable, and silanol group, alkoxy group, and amino group are more preferable.

From the viewpoint of reactivity with the rubber component, crosslinking agent, and crosslinking aid in the sealing member, among the hydrophobic functional groups shown in (b), vinyl group, (meth)acryloyl group, and maleimide group are preferable, and vinyl group is more preferable.

From the viewpoint of obtaining acid-resistant adhesion, particularly the acid-resistant adhesion under the conditions of high temperature and long period, the silane coupling agent shown in (α) needs to have a molar ratio (Ma/Mb) of the substance amount Ma (mol) of hydrophilic functional groups to the substance amount Mb (mol) of hydrophobic functional groups contained in 1 mol of molecules being 0.33 to 3.00. From the same viewpoint, the molar ratio (Ma/Mb) is preferably in the range of 0.40 to 2.90, more preferably in the range of 0.45 to 2.75. The molar ratio (Ma/Mb) may be in the range of 0.45 to 2.00.

Furthermore, from the viewpoint of film formation properties or the like, the silane coupling agent shown in (a) may be of a copolymerized oligomer type. That is, a copolymerized oligomer may be used. That is, by subjecting a silane coupling agent having each functional group shown in (a) or (b) to an oligomerization reaction, the silane coupling agent shown in (a) can be obtained.

Among the silane coupling agents having a hydrophilic functional group shown in (a), examples of the silane coupling agent that also has a hydrophilic functional group other than silanol group and alkoxy group include: 3-aminopropyltrimethoxysilane, 3-aminopropyltriethoxysilane, N-2-(aminoethyl)-3-aminopropylmethyldimethoxysilane, N-2-(aminoethyl)-3-aminopropyltrimethoxysilane, 3-triethoxysilyl-N-(1,3-dimethyl-butylidene) propylamine, 3-isocyanatepropyltriethoxysilane, 3-ureidopropyltrialkoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, 3-carboxypropyltrimethoxysilane, 3-carboxypropyltriethoxysilane, 3-hydroxypropyltrimethoxysilane, and 3-hydroxypropyltriethoxysilane. One of them may be used alone, or two or more thereof may be used in combination.

Among them, 3-aminopropyltrimethoxysilane, 3-aminopropyltriethoxysilane, N-2-(aminoethyl)-3-aminopropylmethyldimethoxysilane, N-2-(aminoethyl)-3-aminopropyltrimethoxysilane, and 3-isocyanatepropyltriethoxysilane are preferable.

Examples of the silane coupling agent having a hydrophobic functional group shown in (b) include: vinyltrimethoxysilane, vinyltriethoxysilane, 3-(meth)acryloxypropyltrimethoxysilane, 3-(meth)acryloxypropyltriethoxysilane, N-(trimethoxysilylpropyl) maleimide, N-(triethoxysilylpropyl) maleimide, p-styryltrimethoxysilane, p-styryltrimethoxysilane, 3-mercaptopropylmethyltrimethoxysilane, 3-phenyltrimethoxysilane, phenyltriethoxysilane, mercaptopropylmethyldiethoxysilane, methyltrimethoxysilane, methyltriethoxysilane, ethyltrimethoxysilane, ethyltriethoxysilane, n-propyltrimethoxysilane, and n-propyltriethoxysilane One of them may be used alone, or two or more thereof may be used in combination.

Among them, vinyltrimethoxysilane, vinyltriethoxysilane, 3-(meth)acryloxypropyltrimethoxysilane, 3-(meth)acryloxypropyltriethoxysilane, N-(trimethoxysilylpropyl) maleimide, and N-(triethoxysilylpropyl) maleimide are preferable.

During the above oligomerization reaction, with respect to 1.0 mol of the silane coupling agent having a hydrophobic functional group shown in (b), for example, 0.5 to 2.0 mol of the silane coupling agent having a hydrophilic functional group shown in (a) without having the hydrophobic functional group mentioned above may be used. 0.2 to 5.0 mol of water for hydrolysis may be used relative to 1 mol of the total substance amount of the silane coupling agent having a hydrophilic functional group shown in (a) and the silane coupling agent having a hydrophobic functional group shown in (b). Among the silane coupling agents having a hydrophilic functional group shown in (a), the silane coupling agent that has a hydrophilic functional group other than silanol group and alkoxy group does not necessarily need to be included.

In the above oligomerization reaction, each raw material mentioned above is charged into a reactor having a distillation device and a stirrer, and stirred at approximately 60° C. for approximately 1 hour. After that, approximately 0.5 to 2.0 mol of an acid such as formic acid relative to 1 mol of the total substance amount of the silane coupling agent having a hydrophilic functional group shown in (a) and the silane coupling agent having a hydrophobic functional group shown in (b) is added within 1 hour. The temperature at this time is maintained at approximately 65° C. While the mixture is further stirred for 1 to 5 hours to advance the reaction, alcohol generated by hydrolysis is distilled under reduced pressure. The distillation is terminated at a time point when only water is present in the distilled water. After that, by dilution and adjustment so as to obtain a silane concentration in the range of 30% to 80% by mass, a copolymerized oligomer (silane coupling agent (α)) can be obtained. This copolymerized oligomer is an oligomer that is soluble in an alcohol-based organic solvent such as methanol and ethanol. From the viewpoint of enhancing film formation properties, water resistance, and acid resistance during application of the adhesive, the copolymerized oligomer is preferably a trimer or higher.

As an adhesive containing the copolymerized oligomer, a commercially available product can be used as is. Specific examples include: Chemlok 5151 [molar ratio (Ma/Mb) of the substance amount Ma (mol) of hydrophilic functional groups to the substance amount Mb (mol) of hydrophobic functional groups contained in 1 mol of the copolymerized oligomer: 1.13], manufactured by Lord Far East; MEGUM 3290 [molar ratio (Ma/Mb) of the substance amount Ma (mol) of hydrophilic functional groups to the substance amount Mb (mol) of hydrophobic functional groups contained in 1 mol of the copolymerized oligomer: 2.70], manufactured by Dow Chemical; X-12-1048 [molar ratio (Ma/Mb) of the substance amount Ma (mol) of hydrophilic functional groups to the substance amount Mb (mol) of hydrophobic functional groups contained in 1 mol of the copolymerized oligomer: 3.00], manufactured by Shin-Etsu Chemical; X-12-1050 [molar ratio (Ma/Mb) of the substance amount Ma (mol) of hydrophilic functional groups to the substance amount Mb (mol) of hydrophobic functional groups contained in 1 mol of the copolymerized oligomer: 1.67], manufactured by Shin-Etsu Chemical; and KR-513 [molar ratio (Ma/Mb) of the substance amount Ma (mol) of hydrophilic functional groups to the substance amount Mb (mol) of hydrophobic functional groups contained in 1 mol of the copolymerized oligomer: 0.49], manufactured by Shin-Etsu Chemical.

### <<Organic Titanate Compound (β)>>

The component (β) is a component that constitutes the adhesive together with the component (α). The component (β) may be used to enhance acid-resistant adhesion, particularly the acid-resistant adhesion between the base material and the sealing member under the conditions of high temperature and long period. As the organic titanate compound (β), it is preferable to use at least one selected from a group consisting of titanium alkoxide, titanium chelate, and titanium acylate.

Examples of the titanium alkoxide include: tetramethyl titanate, tetraethyl titanate, tetra-normal-propyl titanate, tetraisopropyl titanate, tetra-normal-butyl titanate, tetraisobutyl titanate, tetra-t-butyl titanate, tetraoctyl titanate, tetrastearyl titanate, tetra(2-ethylhexyl) titanate, and tetramethyl titanate. Among them, tetraisopropyl titanate, tetra-normal-butyl titanate, and tetrastearyl titanate are suitable.

Examples of the titanium chelate include: titanium acetylacetonate, titanium octylene glycolate, titanium tetraacetylacetonate, titanium ethyl acetoacetate, and titanium triethanol aluminate. Among them, titanium acetylacetonate and titanium ethyl acetoacetate are suitable.

Examples of the titanium acylate include: titanium isostearate, tri-n-butoxytitanium monostearate, di-i-propoxytitanium distearate, titanium stearate, di-i-propoxytitanium diisostearate, and (2-n-butoxycarbonylbenzyloxy)tributoxytitanium. Among them, titanium stearate is suitable.

Among these organic titanate compounds (β), from the viewpoint of further enhancing acid-resistant adhesion, particularly the acid-resistant adhesion between the base material and the sealing member under the conditions of high temperature and long period, titanium alkoxide and titanium chelate are preferable, and titanium alkoxide is more preferable.

Among titanium alkoxides, from the viewpoint of solubility and hydrolyzability, titanium alkoxide in which an alkyl group represented by R¹ in the following formula (1) is an alkyl group having 1 to 18 carbon atoms is preferable, and titanium alkoxide in which the alkyl group is an alkyl group having 2 to 10 carbon atoms is more preferable.

Ti(OR¹)₄ Formula (1)

[In formula (1), R¹ independently represents alkyl groups of the same or different types.]

Specific examples of R¹ in the formula (1) include: methyl group, ethyl group, propyl group, isopropyl group, n-butyl group, sec-butyl group, t-butyl group, n-pentyl group, n-hexyl group, n-heptyl group, n-octyl group, 2-ethylhexyl group, stearyl group, and isostearyl group.

From the viewpoint of acid-resistant adhesion, particularly the acid-resistant adhesion under the conditions of high temperature and long period, a blending amount of the component (β) is preferably 0.5 part by mass or more, more preferably in the range of 1 to 200 parts by mass, further preferably in the range of 3 to 200 parts by mass, and particularly preferably in the range of 5 to 200 parts by mass, relative to 100 parts by mass of the component (α).

If the blending amount of the component (β) is outside the above range, the acid-resistant adhesion under the conditions of high temperature and long period tends to become insufficient.

The blending amount of the component (β) can be appropriately set within the above range. The blending amount of the component (β) may be, for example, in the range of 10 to 150 parts by mass, 30 to 120 parts by mass, or 35 to 70 parts by mass, relative to 100 parts by mass of the component (α).

In addition to the components (α) and (β), phenol resin, bismaleimide resin, vinyl resin or the like may be added to the adhesive that forms the adhesive layer, for the purpose of enhancing adhesion to the base material and ensuring hydrophobicity to thereby prevent water from entering the adhesive layer and improve water resistance and acid resistance. However, the adhesive preferably contains the components (α) and (β) as main components.

The “main components” mentioned above refer to the principal components of the adhesive, and means that a total blending amount of the components (α) and (β) is 50% by mass or more of the adhesive (excluding solvent). The total blending amount of the components (α) and (β) can be appropriately adjusted within the above range. The total blending amount of the components (a) and (B) may be, for example, 60% by mass or more, 70% by mass or more, 80% by mass or more, 90% by mass or more, or 100% by mass, of the adhesive (excluding solvent).

The adhesive that forms the adhesive layer may usually be used as a solution diluted with an organic solvent so that a total amount of the silane coupling agent shown in (a) and the organic titanate compound shown in (B) is approximately 0.5% to 25% by mass. Examples of the organic solvent include: an alcohol-based organic solvent, such as methanol, ethanol, butoxyethanol, isopropanol, and 2-ethoxyethanol (ethylene glycol monoethyl ether); a ketone-based organic solvent, such as acetone, methyl ethyl ketone, methyl isobutyl ketone, and acetylacetone; and a hydrocarbon-based solvent, such as xylene and toluene.

### <Base Material>

Next, the base material will be described.

Examples of a material of the base material include: stainless steel, titanium, copper, magnesium, aluminum, carbon, graphite, and conductive resin (thermoplastic resin or thermosetting resin mixed with graphite, polyacrylonitrile-based carbon fiber or the like). Among them, from the viewpoint of acid resistance, base materials including stainless steel, titanium (pure titanium or titanium alloy), or conductive resin are preferable. From the viewpoint of providing a laminate for fuel cells that is excellent in acid-resistant adhesion, it is preferable to use a base material including austenitic stainless steel. Specific examples of the austenitic stainless steel include: SUS 304, SUS 301, and SUS 316L.

From the viewpoint of acid resistance, it is effective to use a base material including stainless steel, particularly a base material including austenitic stainless steel, as the base material. However, such a base material has a problem of being difficult to adhere to. Accordingly, for example, if only the silane coupling agent (α) is used as the adhesive, there is room for improvement in acid-resistant adhesion under the conditions of high temperature and long period. However, as in the present disclosure, if the organic titanate compound (β) is further blended as a constituent component of the adhesive, it can be said that acid-resistant adhesion can be excellently satisfied even in the case of using a base material including stainless steel, particularly a base material including austenitic stainless steel, as the base material.

From the viewpoint of conduction reliability, a surface of the base material including the above materials may have a carbon thin film such as a diamond-like carbon (DLC) film or graphite film formed by treatment such as physical vapor deposition (PVD) or chemical vapor deposition (CVD). A thickness of the carbon thin film is preferably 10 to 500 nm.

### <Method for Manufacturing Laminate>

Next, a method for manufacturing the present laminate for fuel cells will be described.

First, as described above, the present rubber composition for forming the sealing member is prepared. The present rubber composition is subjected to die molding, press molding or the like, and a flat plate-shaped rubber member having a predetermined thickness is fabricated.

The flat plate-shaped rubber member may be crosslinked or uncrosslinked. From the viewpoint of enhancing adhesion, the flat plate-shaped rubber member is preferably uncrosslinked.

Then, an adhesive containing the silane coupling agent (α) and the organic titanate compound (β) is applied onto the base material such as a stainless steel plate by any method such as a spray method, a dipping method, or a roll coating method, and is dried at room temperature if necessary. After that, the flat plate-shaped rubber member is laminated on a surface of the resultant base material, and crosslinking and bonding are performed under predetermined conditions (such as at 130 to 200° C. for 3 to 30 minutes), whereby a laminate can be fabricated in which the base material and the crosslinked rubber member (scaling member) are bonded.

If the crosslinked rubber member is molded into a predetermined shape in advance according to the shape of the sealing member, complex positioning is unnecessary, continuous machining is facilitated and productivity is improved, which is therefore favorable.

The crosslinked rubber member may be formed by crosslinking the present rubber composition prepared as above using a predetermined mold on the base material having the adhesive applied thereon as described above. By doing so, crosslinking and bonding are further strengthened.

The thickness or the like of each member in the present laminate for fuel cells varies depending on a scaling portion where the laminate is used. For example, the thickness of the base material is usually in the range of 0.05 to 5 mm, preferably in the range of 0.1 to 3 mm. The thickness of the sealing member is usually in the range of 0.2 to 5 mm, preferably in the range of 0.5 to 3 mm. The thickness of the adhesive layer is usually in the range of 1×10⁻⁵ to 0.025 mm, preferably in the range of 2×10⁻⁵ to 0.002 mm. The adhesive layer can be multiple layers of two or more layers. From the viewpoint of shortening a coating process, the adhesive layer is preferably a single layer.

### <Member for Constituting Fuel Cell>

The present laminate for fuel cells may be used as a member for constituting a fuel cell.

Examples of the member for constituting a fuel cell include a laminate formed in which a base material for fuel cells and a sealing member that seals the base material are bonded via an adhesive layer.

The base material for fuel cells varies depending on the type and structure or the like of the fuel cell, and examples thereof include: a separator, a gas diffusion layer (GDL), and a membrane electrode assembly (MEA) (electrolyte membrane and electrode).

Examples of the separator include: a separator made of metal including stainless steel (SUS 304), titanium or the like; and a separator including conductive resin (thermoplastic resin or thermosetting resin mixed with graphite, polyacrylonitrile-based carbon fiber or the like). The separator may also have a carbon thin film such as DLC film or graphite film formed on a surface of the separator including the above metal by treatment such as PVD or CVD.

Examples of the fuel cell as an applicable object include a solid polymer type fuel cell (polymer electrolyte fuel cell (PEFC)) (including a direct methanol fuel cell (DMFC)).

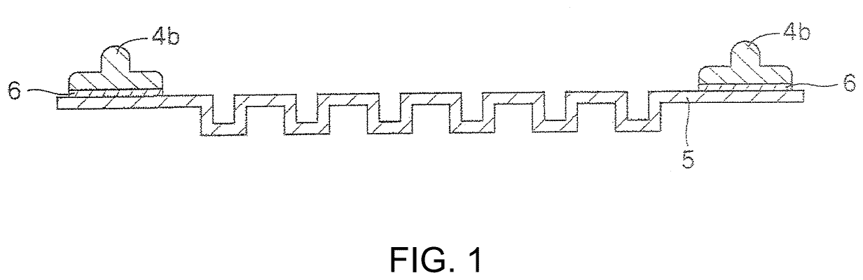

An example of the present laminate for fuel cells is shown in FIG. 1. FIG. 1 shows a member in which a lip 4b having a rectangular shape and a convex cross-sectional shape is provided via an adhesive layer 6 at a peripheral part of a separator 5, the separator 5 having a rectangular thin plate shape, having a total of six grooves provided in a depressed manner and extending in a longitudinal direction, and having an uneven cross-sectional shape. The lip 4b is a sealing member including the present rubber composition that contains the rubber component (A). The adhesive layer 6 includes an adhesive containing the silane coupling agent (α) and the organic titanate compound (β).

### <Fuel Cell Seal Body>

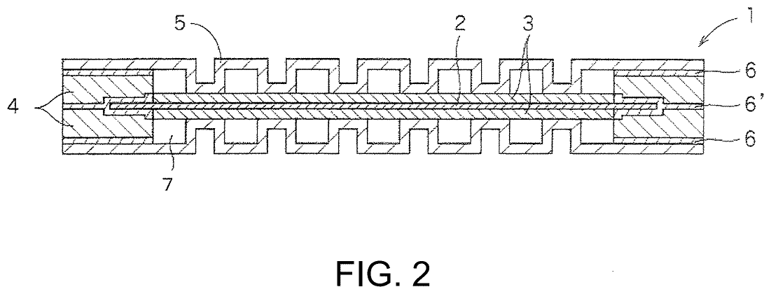

Next, an example of a fuel cell seal body using the laminate for fuel cells according to the present disclosure is shown in FIG. 2. FIG. 2 mainly shows a single cell 1 in a fuel cell formed in which multiple cells are stacked. The cell 1 includes an MEA 2, a gas diffusion layer (GDL) 3, a sealing member 4, the separator 5, and the adhesive layer 6. The sealing member 4 includes the present rubber composition that contains the rubber component (A). The adhesive layer 6 includes an adhesive containing the silane coupling agent (α) and the organic titanate compound (β).

Examples of the fuel cell seal body include: a fuel cell seal body formed in which the separator 5 and the sealing member 4 are bonded via the adhesive layer 6, as shown in FIG. 2; a fuel cell seal body formed in which the MEA 2 and the sealing member 4 are bonded via the adhesive layer 6; and a fuel cell seal body formed in which the gas diffusion layer 3 and the sealing member 4 are bonded via the adhesive layer 6.

An adhesive layer 6′ that bonds adjacent sealing members 4 to each other may be a layer including the adhesive that contains the silane coupling agent (α) and the organic titanate compound (β). The adhesive layer may include, for example, rubber cement, or a rubber composition (such as liquid ethylene propylene rubber (liquid EPM), liquid EPDM, liquid acrylonitrile-butadiene rubber (liquid NBR), or liquid hydrogenated acrylonitrile-butadiene rubber (liquid H—NBR)) that is liquid at room temperature (23° C.).

Although not illustrated, the MEA 2 includes an electrolyte membrane, and a pair of electrodes arranged on both sides in a stacking direction with the electrolyte membrane sandwiched therebetween. The electrolyte membrane and the pair of electrodes have a rectangular thin plate shape. The gas diffusion layer 3 is arranged on both sides in the stacking direction with the MEA 2 sandwiched therebetween. The gas diffusion layer 3 is a porous layer and has a rectangular thin plate shape.

The separator 5 is made of titanium, has a rectangular thin plate shape, and has a total of six grooves provided in a depressed manner and extending in the longitudinal direction. Due to these grooves, the separator 5 has an uneven shape in cross-section. The separators 5 are arranged facing each other on both sides of the gas diffusion layer 3 in the stacking direction. Between the gas diffusion layer 3 and the separator 5, a gas flow path 7 for supplying gas to the electrode is defined utilizing the uneven shape.

The sealing member 4 has a rectangular frame shape. The sealing member 4 is bonded to a peripheral part of the MEA 2 or gas diffusion layer 3, and to the separator 5 via the adhesive layer 6, and seals the peripheral part of the MEA 2 or gas diffusion layer 3. In the example of FIG. 2, the sealing member 4 uses two members divided into an upper member and a lower member. However, the sealing member 4 may also be a single sealing member in which two members are combined.

During operation of a fuel cell such as a solid polymer type fuel cell, fuel gas and oxidant gas are each supplied through the gas flow path 7. Here, the peripheral part of the MEA 2 is sealed by the sealing member 4 via the adhesive layer 6. Hence, gas mixing or leakage does not occur.

### <Fuel Cell Including Laminate for Fuel Cells or the Like>

Examples of one embodiment of the present disclosure include a fuel cell including the present laminate for fuel cells, and a fuel cell vehicle (FCV) or the like that includes the fuel cell.

That is, examples of one embodiment of the present disclosure include the following fuel cell. That is, the fuel cell includes a laminate for fuel cells formed in which a base material and a scaling member are bonded via an adhesive layer. The sealing member includes the present rubber composition that contains the component (A). The adhesive layer includes an adhesive that contains the component (α) and the component (β).

Examples of one embodiment of the present disclosure include the following fuel cell vehicle (FCV). That is, the fuel cell vehicle (FCV) includes a fuel cell including a laminate for fuel cells formed in which a base material and a sealing member are bonded via an adhesive layer. The sealing member includes the present rubber composition that contains the component (A). The adhesive layer includes an adhesive that contains the component (α) and the component (β).

### EXAMPLES

The present disclosure will be described below more specifically by giving examples. However, the present disclosure is not limited to the following examples as long as it does not exceed the gist thereof.

First, rubber compositions, adhesives and base materials shown below were prepared.

### <Rubber Composition (R1)>

### <<Rubber Composition (R¹)>>

100 parts by mass of ethylene-butene-diene rubber (manufactured by Mitsui Chemicals, Inc.; EBT-K-9330M), 1 part by mass of an antioxidant (manufactured by Ouchi Shinko Chemical Industrial Co., Ltd.; Nocrac NS-5), 50 parts by mass of carbon black (manufactured by Tokai Carbon Co., Ltd.; FEF grade carbon black; Seast SO), and 15 parts by mass of a plasticizer (manufactured by Nippon Steel Chemical & Material Co., Ltd.; poly-α-olefin; PAO601) were kneaded at 120° C. for 5 minutes using a Banbury mixer. After the kneaded mixture was cooled, 6 parts by mass of a crosslinking agent (manufactured by NOF Corporation; Perhexac C-80) were added, and the mixture was further kneaded at 50° C. for 10 minutes using an open roll to prepare a rubber composition (R1).

### <<Rubber Composition (R2)>>

A rubber composition (R2) was prepared in the same manner as the rubber composition (R1), except that ethylene-butene-diene rubber (manufactured by Mitsui Chemicals, Inc.; EBT-K-9330M) was changed to ethylene-propylene-diene rubber (manufactured by Mitsui Chemicals, Inc.; EPT-9090M).

### <<Rubber Composition (R3)>>

A rubber composition (R3) was prepared in the same manner as the rubber composition (R1), except that ethylene-butene-diene rubber (manufactured by Mitsui Chemicals, Inc.; EBT-K-9330M) was changed to ethylene-propylene-diene rubber (manufactured by Sumitomo Chemical Co., Ltd.; Esprene 5361).

### <Adhesive>

The adhesive materials shown below were prepared.

### <<Silane Coupling Agent (α1)>>

100 parts by mass of vinyltrimethoxysilane, 68.4 parts by mass of 3-aminopropyltrimethoxysilane, and 33.1 parts by mass (1.74 mol relative to 1 mol of a total substance amount of the above silane coupling agents) of water were charged into a reactor having a distillation device and a stirrer, and stirred at approximately 60° C. for approximately 1 hour. After that, an acid such as formic acid was added within 1 hour so that the amount thereof added was approximately 0.5 to 2.0 mol relative to 1 mol of the total substance amount of the above silane coupling agents. The temperature at this time was maintained at approximately 65° C. While the mixture was further stirred for 1 to 5 hours to advance the reaction, alcohol generated by hydrolysis was distilled under reduced pressure. The distillation was terminated at a time point when only water was present in the distilled water, and the mixture was then diluted and adjusted so as to obtain a silane concentration of 30% to 80% by mass, thereby obtaining a copolymerized oligomer having a molar ratio (Ma/Mb) of the substance amount Ma (mol) of hydrophilic functional groups to the substance amount Mb (mol) of hydrophobic functional groups contained in 1 mol of molecules being 1.17. The hydrophobic functional group is a vinyl group, and the hydrophilic functional group is a silanol group, alkoxy group, or amino group.

### <<Silane Coupling Agent (α2)>>

X-12-1050 [in which a molar ratio (Ma/Mb) of the substance amount Ma (mol) of hydrophilic functional groups to the substance amount Mb (mol) of hydrophobic functional groups contained in 1 mol of the copolymerized oligomer is 1.67, the hydrophobic functional group is an acryloyl group, and the hydrophilic functional group is a silanol group or alkoxy group.], manufactured by Shin-Etsu Chemical Co., Ltd.

### <<Silane Coupling Agent (α3)>>

KR-513 [in which a molar ratio (Ma/Mb) of the substance amount Ma (mol) of hydrophilic functional groups to the substance amount Mb (mol) of hydrophobic functional groups contained in 1 mol of the copolymerized oligomer is 0.49, the hydrophobic functional group is an acryloyl group or methyl group, and the hydrophilic functional group is a silanol group or alkoxy group.], manufactured by Shin-Etsu Chemical Co., Ltd.

### <<Silane Coupling Agent (α′1)>>

X-12-972F [in which the functional group in the copolymerized oligomer includes only a hydrophilic functional group, and the hydrophilic functional group is a silanol group, alkoxy group, or amino group.], manufactured by Shin-Etsu Chemical Co., Ltd.

### <<Silane Coupling Agent (α′2)>>

X-24-9590 [in which the functional group in the copolymerized oligomer includes only a hydrophilic functional group, and the hydrophilic functional group is a silanol group, alkoxy group, or amino group.], manufactured by Shin-Etsu Chemical Co., Ltd.

### <<Titanium Alkoxide (β1-1)>>

Tetraisopropyl titanate (manufactured by Nippon Soda Co., Ltd.; A-1)

### <<Titanium Alkoxide (β1-2)>>

Tetra-n-butyl titanate (manufactured by Nippon Soda Co., Ltd.; B-1)

### <<Titanium Alkoxide (β1-3)>>

Tetrastearyl titanate (manufactured by Matsumoto Fine Chemical Co., Ltd.; Orgatix TA-90)

### <<Titanium Acylate (β2)>>

Titanium stearate (manufactured by Nippon Soda Co., Ltd.; S-151)

### <<Titanium Chelate (β3-1)>>

Titanium acetylacetonate (manufactured by Matsumoto Fine Chemical Co., Ltd.; Orgatix TC-100)

### <<Titanium Chelate (β3-2)>>

Titanium ethyl acetoacetate (manufactured by Matsumoto Fine Chemical Co., Ltd.; Orgatix TC-710)

### <<Organic Titanate Compound (β′1)>>

Titanium oxide (manufactured by Sakai Chemical Industry Co., Ltd.; SSP-M)

### <<Organic Titanate Compound (β′2)>>

Titanium oxide (manufactured by Sakai Chemical Industry Co., Ltd.; STR-100N)

### <Base Material>

The base materials shown below were prepared.

### <<SUS (1)>>

Base material made of stainless steel (SUS 304) (having a width of 25 mm, a length of 60 mm, and a thickness of 1.5 mm)

### <<SUS (2)>>

Base material made of stainless steel (SUS 316) (having a width of 25 mm, a length of 60 mm, and a thickness of 1.5 mm)

### Example 1

Titanium alkoxide (β1-1) was mixed at a ratio of 0.5 part by mass relative to 100 parts by mass of the silane coupling agent (α1), and was diluted with an alcohol-based organic solvent containing ethanol and butoxyethanol to prepare an adhesive having a solid content concentration of 10% by mass (an adhesive in which a total blending amount of the silane coupling agent (α1) and titanium alkoxide (β1-1) was 10% by mass, the content of ethanol was 85% by mass, and the content of butoxyethanol was 5% by mass).

SUS (1) was prepared as a base material. The adhesive previously prepared was spray-applied on a surface of the base material in a range defined in JIS K 6256-2 so as to have a thickness of approximately 0.5 μm after application. After that, the rubber composition (R1) and the base material were crosslinked and bonded by being held at 170° C. for 15 minutes using a predetermined mold to have a shape in accordance with JIS K 6256-2. An adhesion evaluation sample (laminate) was fabricated in which a rubber molded body (sealing member) having a thickness of 2.0 mm and the base material were bonded via an adhesive layer (having a thickness of 0.5 μm).

### Example 2 to Example 15 and Comparative Example 1 to Comparative Example 7

Adhesion evaluation samples (laminates) according to Example 2 to Example 15 and Comparative Example 1 to Comparative Example 7 were fabricated in the same manner as Example 1, except that the type of rubber composition, the type and blending ratio of silane coupling agent and titanate compound, and the type of base material were changed as shown in Table 1 and Table 2.

For example, in Example 2, the adhesion evaluation sample (laminate) was fabricated as follows.

Titanium alkoxide (β1-1) was mixed at a ratio of 5 parts by mass relative to 100 parts by mass of the silane coupling agent (α1), and was diluted with an alcohol-based organic solvent containing ethanol and butoxyethanol to prepare an adhesive having a solid content concentration of 10% by mass (an adhesive in which a total blending amount of the silane coupling agent (α1) and titanium alkoxide (β1-1) was 10% by mass, the content of ethanol was 85% by mass, and the content of butoxyethanol was 5% by mass).

SUS (1) was prepared as a base material. The adhesive previously prepared was spray-applied on a surface of the base material in a range defined in JIS K 6256-2 so as to have a thickness of approximately 0.5 μm after application. After that, the rubber composition (R¹) and the base material were crosslinked and bonded by being held at 170° C. for 15 minutes using a predetermined mold to have a shape in accordance with JIS K 6256-2. An adhesion evaluation sample (laminate) was fabricated in which a rubber molded body (sealing member) having a thickness of 2.0 mm and the base material were bonded via an adhesive layer (having a thickness of 0.5 μm).

The adhesion evaluation samples (laminates) of the examples and comparative examples obtained in this manner were evaluated for each property in accordance with the following criteria. The results thereof are shown together in Table 1 to Table 3 described later.

### <Initial Adhesion Evaluation Test>

The adhesion evaluation samples (laminates) obtained as described above were subjected to a 90° peeling test defined in JIS K 6256-2 (2006) in a normal-temperature (23° C.) environment and were visually observed. The adhesion between the base material and the rubber molded body (sealing member) in each adhesion evaluation sample (laminate) was evaluated according to the following criteria. The results thereof are shown in Table 1 and Table 2.

### (Evaluation Criteria)

∘ (very good): there was material failure of the rubber molded body (sealing member).
x (poor): there was no material failure of the rubber molded body (sealing member).

### <Acid-Resistant Adhesion Evaluation Test (1) Under Conditions of High Temperature and Long Period>

The adhesion evaluation samples (laminates) of the examples and comparative examples were put into a sulfuric acid aqueous solution adjusted to pH=3.0, and were immersed in the sulfuric acid aqueous solution at 120° C. for 336 hours (or 672 hours). After that, the adhesion evaluation samples were taken out from the sulfuric acid aqueous solution and left to stand for one day. Then, the adhesion evaluation samples were subjected to a 90° peeling test in accordance with JIS K 6256-2 (2006), visually observed, and evaluated according to the following criteria. The results thereof are shown in Table 1 and Table 2.

Symbol “-” in the column of evaluation in Table 2 indicates that the acid-resistant adhesion was not evaluated because the initial adhesion evaluation was “x.”

### (Evaluation Criteria)

⊚ (excellent): a total ratio of material failure of the rubber molded body and cohesive failure of the adhesive layer exceeded 80%.
∘ (very good): a total ratio of material failure of the rubber molded body and cohesive failure of the adhesive layer was 50% to 80%.
Δ (good): there were material failure of the rubber molded body and cohesive failure of the adhesive layer, and a total ratio thereof was less than 50%.
x (poor): a ratio of interfacial peeling was approximately 100%.

### <Acid-Resistant Adhesion Evaluation Test (2) Under Conditions of High Temperature and Long Period>

Next, in order to verify the influence of the type of organic titanate compound on acid-resistant adhesion, a test was conducted in which the immersion time was further extended.

Specifically, Example 3, Example 8, and Example 9 are examples that differ only in the type of organic titanate compound. Example 3 employed titanium alkoxide, Example 8 employed titanium acylate, and Example 9 employed titanium chelate.

The adhesion evaluation sample (laminate) of Example 3, Example 8, or Example 9 was put into a sulfuric acid aqueous solution adjusted to pH=3.0, and was immersed in the sulfuric acid aqueous solution at 120° C. for 840 hours. After that, the adhesion evaluation sample was taken out from the sulfuric acid aqueous solution and left to stand for one day. Then, the adhesion evaluation sample were subjected to a 90° peeling test in accordance with JIS K 6256-2 (2006), visually observed, and evaluated according to the criteria of <Acid-resistant Adhesion Evaluation Test (1) Under Conditions of High Temperature and Long Period> described above. Results thereof are shown in Table 3.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Adhesive | Silane coupling | 100 | 100 | 100 | 100 | 100 | 100 | 100 | 100 | 100 | 100 | — |
| layer | agent (α1) | | | | | | | | | | | |
| | [Ma/Mb = 1.17] | | | | | | | | | | | |
| | Silane coupling | — | — | — | — | — | — | — | — | — | — | 100 |
| | agent (α2) | | | | | | | | | | | |
| | [Ma/Mb = 1.67] | | | | | | | | | | | |
| | Silane coupling | — | — | — | — | — | — | — | — | — | — | — |
| | agent (α3) | | | | | | | | | | | |
| | [Ma/Mb = 0.49] | | | | | | | | | | | |
| | Titanium | 0.5 | 5 | 50 | 100 | 200 | — | — | — | — | — | 50 |
| | alkoxide (β1-1) | | | | | | | | | | | |
| | Titanium | — | — | — | — | — | 50 | — | — | — | — | — |
| | alkoxide (β1-2) | | | | | | | | | | | |
| | Titanium | — | — | — | — | — | — | 50 | — | — | — | — |
| | alkoxide (β1-3) | | | | | | | | | | | |
| | Titanium acylate | — | — | — | — | — | — | — | 50 | — | — | — |
| | (β2) | | | | | | | | | | | |
| | Titanium chelate | — | — | — | — | — | — | — | — | 50 | — | — |
| | (β3-1) | | | | | | | | | | | |
| | Titanium chelate | — | — | — | — | — | — | — | — | — | 50 | — |
| | (β3-2) | | | | | | | | | | | |
| Sealing member | | Rubber composition (R1) | | | | | | | | | | |
| Base material | | SUS (1) | | | | | | | | | | |
| Evaluation | Initial adhesion | ◯ | ◯ | ◯ | ◯ | ◯ | ◯ | ◯ | ◯ | ◯ | ◯ | ◯ |
| | Acid-resistant | ⊚ | ⊚ | ⊚ | ⊚ | ⊚ | ⊚ | ⊚ | ⊚ | ⊚ | ⊚ | ⊚ |
| | adhesion at | | | | | | | | | | | |
| | 120° C. for 336 h | | | | | | | | | | | |
| | Acid-resistant | ◯ | ⊚ | ⊚ | ⊚ | ⊚ | ⊚ | ⊚ | ⊚ | ⊚ | ⊚ | ⊚ |
| | adhesion at | | | | | | | | | | | |
| | 120° C. for 672 h | | | | | | | | | | | |

| | | Example | | | |
|---|---|---|---|---|---|
| | | 12 | 13 | 14 | 15 |
| Adhesive | Silane coupling | — | 100 | 100 | 100 |
| layer | agent (α1) | | | | |
| | [Ma/Mb = 1.17] | | | | |
| | Silane coupling | — | — | — | — |
| | agent (α2) | | | | |
| | [Ma/Mb = 1.67] | | | | |
| | Silane coupling | 100 | — | — | — |
| | agent (α3) | | | | |
| | [Ma/Mb = 0.49] | | | | |
| | Titanium | 50 | 50 | 50 | 50 |
| | alkoxide (β1-1) | | | | |
| | Titanium | — | — | — | — |
| | alkoxide (β1-2) | | | | |
| | Titanium | — | — | — | — |
| | alkoxide (β1-3) | | | | |
| | Titanium acylate | — | — | — | — |
| | (β2) | | | | |
| | Titanium chelate | — | — | — | — |
| | (β3-1) | | | | |
| | Titanium chelate | — | — | — | — |
| | (β3-2) | | | | |
| Sealing member | | Rubber composition (R1) | | Rubber composition (R2) | Rubber composition (R3) |
| Base material | | SUS (1) | SUS (2) | SUS (1) | |
| Evaluation | Initial adhesion | ◯ | ◯ | ◯ | ◯ |
| | Acid-resistant | ⊚ | ⊚ | ⊚ | ⊚ |
| | adhesion at | | | | |
| | 120° C. for 336 h | | | | |
| | Acid-resistant | ⊚ | ⊚ | ⊚ | ⊚ |
| | adhesion at | | | | |
| | 120° C. for 672 h | | | | |

TABLE 2

| | | Comparative Example | | | | | | |
|---|---|---|---|---|---|---|---|---|
| | | 1 | 2 | 3 | 4 | 5 | 6 | 7 |
| Adhesive layer | Silane coupling agent | 100 | — | — | — | — | 100 | 100 |
| | (α1) [Ma/Mb = 1.17] | | | | | | | |
| | Silane coupling agent | — | 100 | — | — | — | — | — |
| | (α3) [Ma/Mb = 0.49] | | | | | | | |
| | Silane coupling agent | — | — | — | 100 | — | — | — |
| | (α′1)[without | | | | | | | |
| | (b) hydrophobic group] | | | | | | | |
| | Silane coupling agent (α′2)[without | — | — | — | — | 100 | — | — |
| | (b) hydrophobic group] | | | | | | | |
| | Titanium alkoxide (β1-1) | — | — | 100 | 50 | 50 | — | — |
| | Organic titanate compound (β′1) | — | — | — | — | — | 5 | — |
| | Organic titanate compound (β′2) | — | — | — | — | — | — | 5 |
| Sealing member | | Rubber composition (R1) | | | | | | |
| Base material | | SUS (1) | | | | | | |
| Evaluation | Initial adhesion | ◯ | ◯ | X | X | X | ◯ | ◯ |
| | Acid-resistant adhesion | X | X | — | — | — | X | X |
| | at 120° C. for 336 h | | | | | | | |

TABLE 3

| | | Example | | |
|---|---|---|---|---|
| | | 3 | 8 | 9 |
| Adhesive | Silane coupling agent (α1) | 100 | 100 | 100 |
| layer | [Ma/Mb = 1.17] | | | |
| | Titanium alkoxide (β1-1) | 50 | — | — |
| | Titanium acylate (β2) | — | 50 | — |
| | Titanium chelate (β3-1) | — | — | 50 |
| Sealing member | | Rubber composition (R1) | | |
| Base material | | SUS (1) | | |
| Evaluation | Acid-resistant adhesion at | ⊚ | Δ | ◯ |
| | 120° C. for 840 h | | | |

### <Results of Acid-resistant Adhesion Evaluation Test (1) Under Conditions of High Temperature and Long Period>

From the results of Table 1 and Table 2 above, all of the adhesion evaluation samples (laminates) of the examples were good in “initial adhesion,” and were further evaluated as being excellent in the evaluations for “acid-resistant adhesion at 120° C. for 336 h” and “acid-resistant adhesion at 120° C. for 672 h.”

In contrast, since the adhesion evaluation samples (laminates) of Comparative Example 1 and Comparative Example 2 did not employ the organic titanate compound (β) defined in the present disclosure, the adhesion evaluation samples were inferior in the evaluation for “acid-resistant adhesion at 120° C. for 336 h,” and an unsatisfactory result was obtained in terms of acid-resistant adhesion under the conditions of high temperature and long period.

Since the adhesion evaluation sample (laminate) of Comparative Example 3 did not employ the silane coupling agent (α) defined in the present disclosure, an inferior result was obtained in the evaluation for “initial adhesion.” Specifically, the interfacial peeling between the rubber molded body (sealing member) and the adhesive layer was observed, and an unsatisfactory result in terms of adhesion was obtained. Since Comparative Example 4 and Comparative Example 5 did not employ the silane coupling agent (α) defined in the present disclosure but employed other silane coupling agents (α′), an inferior result was obtained in the evaluation for “initial adhesion.” Specifically, the interfacial peeling between the rubber molded body (sealing member) and the adhesive layer was observed, and an unsatisfactory result in terms of adhesion was obtained. In this way, since Comparative Example 3 to Comparative Example 5 were unsatisfactory in terms of initial adhesion, it was easily estimated that Comparative Example 3 to Comparative Example 5 would also obtain an unsatisfactory result in terms of acid-resistant adhesion under the conditions of high temperature and long period.

Since Comparative Example 6 and Comparative Example 7 did not employ the organic titanate compound (β) defined in the present disclosure but employed inorganic titanate compounds (β′), Comparative Example 6 and Comparative Example 7 were inferior in the evaluation for “acid-resistant adhesion at 120° C. for 336 h,” and an unsatisfactory result was obtained in terms of acid-resistant adhesion under the conditions of high temperature and long period.

From the above, it is shown that a laminate satisfying the requirements defined in the present disclosure is excellent in initial adhesion and in acid-resistant adhesion under the conditions of high temperature and long period.

### <Results of Acid-Resistant Adhesion Evaluation Test (2) Under Conditions of High Temperature and Long Period>

As shown in Table 1 above, Example 3, Example 8, and Example 9 were all excellent in acid-resistant adhesion. From the results of Table 3 above, among Example 3, Example 8, and Example 9, Example 3 and Example 9 were excellent, with Example 3 exhibiting a particularly excellent result.

From the above, it is shown that, by using titanium alkoxide or titanium chelate as the organic titanate compound (β), the acid-resistant adhesion under the conditions of high temperature and long period can be further enhanced. In comparison between the two, it is shown that titanium alkoxide is more preferable.

In the above examples, specific forms in the present disclosure are shown. However, the above examples are merely illustrative and should not be interpreted in a limiting manner. Various modifications apparent to those skilled in the art are intended to be within the scope of the present disclosure.

The laminate of the present disclosure includes a sealing member that is bonded to various base materials via an adhesive layer, and can be suitably used for a laminate for fuel cell seals formed in which a base material for fuel cells such as a metal separator and a sealing member are bonded via an adhesive layer.

1. A laminate for fuel cells, formed in which a base material and a sealing member are bonded via an adhesive layer, wherein
the sealing member comprises a rubber composition containing a component (A); and
the adhesive layer comprises an adhesive containing a component (α) and a component (β):
(A) at least one of ethylene-propylene-diene rubber and ethylene-butene-diene rubber;
(α) a copolymerized oligomer type silane coupling agent having a hydrophilic functional group and a hydrophobic functional group, wherein the hydrophilic functional group is (a), the hydrophobic functional group is (b), and a molar ratio (Ma/Mb) of a substance amount Ma (mol) of hydrophilic functional groups to a substance amount Mb (mol) of hydrophobic functional groups contained in 1 mol of molecules is 0.33 to 3.00:
(a) at least one selected from a group consisting of silanol group, alkoxy group, amino group, isocyanate group, epoxy group, ureido group, carboxy group, and hydroxy group, and containing at least silanol group or alkoxy group;
(b) at least one selected from a group consisting of vinyl group, (meth)acryloyl group, maleimide group, methyl group, ethyl group, styryl group, phenyl group, and mercapto group;
(β) an organic titanate compound.

2. The laminate for fuel cells according to claim 1, wherein the component (β) in the adhesive is at least one of titanium alkoxide and titanium chelate.

3. The laminate for fuel cells according to claim 1, wherein a blending amount of the component (β) in the adhesive is 0.5 to 200 parts by mass relative to 100 parts by mass of the component (α).

4. The laminate for fuel cells according to claim 1, wherein the base material is a base material comprising austenitic stainless steel.
